(19) United States
(12) Patent Application Publication
(10) Pub. No.: US 2002/0101953 A1
(43) Pub. Date: Aug. 1, 2002

(54) Application of noble metals to internal surfaces of operating boiling water reactors in the presence of zinc in reactor water

(75) Inventors: Samson Hettiarachchi, Menlo Park, CA (US); David P. Siegwarth, San Jose, CA (US); Robert L. Cowan, Livermore, CA (US); Robert J. Law, Livermore, CA (US); Thomas P. Diaz, San Martin, CA (US)

Correspondence Address: NIXON & VANDERHYE P.C., 8th Floor, 1100 North Glebe Road, Arlington, VA, 22201-4714, US

(73) Assignee: GENERAL ELECTRIC COMPANY

(21) Appl. No.: 10/109,662

(22) Filed: Apr. 1, 2002

Related U.S. Application Data
(62) Division of application No. 09/559,663, filed on Apr. 28, 2000.
Application No. 09/559,663 is a division of application No. 09/227,893, filed on Jan. 11, 1999, now abandoned.
(60) Provisional application No. 60/103,983, filed on Oct. 13, 1998.

(51) Int. Cl. G21C 9/00

(52) U.S. Cl. 376/306

(57) ABSTRACT

Method for reducing corrosion of alloy components in a water cooled nuclear reactor or associated components comprising the step of injecting into the water of the reactor in the presence of zinc a noble metal cation-releasing compound which releases noble metal cations or cationic species containing noble metal species into the reactor water under operating reactor thermal conditions.

### FIELD OF THE INVENTION

This invention relates generally to reducing the corrosion potential of components exposed to high-temperature water. More particularly, the invention relates to the application of noble metals onto operating reactor surfaces in the presence of zinc to obtain adequate loading of reactor surfaces with noble metal and improved protection from corrosion and intergranular stress corrosion cracking (IGSCC).

### BACKGROUND OF THE INVENTION

Nuclear reactors are used in central-station electric power generation, research and propulsion. A reactor pressure vessel contains the reactor coolant, i.e. water, which removes heat from the nuclear core. Respective piping circuits carry the heated water or steam to the steam generators or turbines and carry circulated water or feedwater back to the vessel. Operating pressures and temperatures for the reactor pressure vessel are about 7 MPa and 288° C. for a boiling water reactor (BWR), and about 15 MPa and 320° C. for a pressurized water reactor (PWR). The materials used in both BWRs and PWRs must withstand various loading, environmental and radiation conditions.

Some of the materials exposed to high-temperature water include carbon steel, alloy steel, stainless steel, nickel-based, cobalt-based and zirconium-based alloys. Despite careful selection and treatment of these materials for use in water reactors, corrosion occurs in the materials exposed to the high-temperature water. Such corrosion contributes to a variety of problems, e.g., stress corrosion cracking, crevice corrosion, erosion corrosion, sticking of pressure relief valves and buildup of the gamma radiation-emitting Co-60 isotope.

Stress corrosion cracking (SCC) is a known phenomenon occurring in reactor components, such as structural members, piping, fasteners and welds exposed to high-temperature water. As used herein, SCC refers to cracking propagated by static or dynamic tensile stressing in combination with corrosion at the crack tip. The reactor components are subject to a variety of stresses associated with, e.g., differences in thermal expansion, the operating pressure needed for the containment of the reactor cooling water, and other sources such as residual stress from welding, cold working and other asymmetric metal treatments. In addition, water chemistry, welding, heat treatment, and radiation can increase the susceptibility of metal in a component to SCC.

It is well known that SCC occurs at higher rates when oxygen is present in the reactor water in concentrations of about 5 ppb or greater. SCC is further increased in a high radiation flux where oxidizing species, such as oxygen, hydrogen peroxide, and short-lived radicals, are produced from radiolytic decomposition of the reactor water. Such oxidizing species increase the electrochemical corrosion potential (ECP) of metals. Electrochemical corrosion is caused by a flow of electrons from anodic to cathodic areas on metallic surfaces. The ECP is a measure of the thermodynamic tendency for corrosion phenomena to occur, and is a fundamental parameter in determining rates of, e.g., SCC, corrosion fatigue, corrosion film thickening, and general corrosion.

In a BWR, the radiolysis of the primary water coolant in the reactor core causes the net decomposition of a small fraction of the water to the chemical products H₂, H₂O₂, O₂ and oxidizing and reducing radicals. For steady-state operating conditions, equilibrium concentrations of O₂, H₂O₂, and H₂ are established in both the water which is recirculated and the steam going to the turbine. The O₂ and H₂O₂ generated are oxidizing and result in conditions that can promote intergranular stress corrosion cracking (IGSCC) of susceptible materials of construction. One method employed to mitigate IGSCC of susceptible material is the application of hydrogen water chemistry (HWC), whereby the oxidizing nature of the BWR environment is modified to a more reducing condition. This effect is achieved by adding hydrogen gas to the reactor feedwater. When the hydrogen reaches the reactor vessel, it reacts with the radiolytically formed oxidizing species to reform water, thereby lowering the concentration of dissolved oxidizing species in the water in the vicinity of metal surfaces. The rate of these recombination reactions is dependent on local radiation fields, water flow rates and other variables.

The injected hydrogen reduces the level of oxidizing species in the water, such as dissolved oxygen, and as a result lowers the ECP of metals in the water. However, factors such as variations in water flow rates and the time or intensity of exposure to neutron or gamma radiation result in the production of oxidizing species at different levels in different reactors. Thus, varying amounts of hydrogen have been required to reduce the level of oxidizing species sufficiently to maintain the ECP below a critical potential required for mitigation from IGSCC in high-temperature water. As used herein, the term “critical potential” means a corrosion potential at or below a range of values of about −0.230 to −0.300 V based on the standard hydrogen electrode (SHE) scale. IGSCC proceeds at an accelerated rate in systems in which the ECP is above the critical potential, and at a substantially lower or zero rate in systems in which the ECP is below the critical potential. Water containing oxidizing species such as oxygen increases the ECP of metals exposed to the water above the critical potential, whereas water with little or no oxidizing species results in an ECP below the critical potential.

Corrosion potentials of stainless steels in contact with reactor water containing oxidizing species can be reduced below the critical potential by injection of hydrogen into the water so that the dissolved hydrogen concentration is about 50 to 100 ppb or greater. For adequate feedwater hydrogen addition rates, conditions necessary to inhibit IGSCC can be established in certain locations of the reactor. Different locations in the reactor system require different levels of hydrogen addition. Much higher hydrogen injection levels are necessary to reduce the ECP within the high radiation flux of the reactor core, or when oxidizing cationic impurities, e.g., cupric ion, are present.

It has been shown that IGSCC of Type 304 stainless steel (e.g., composition in weight % 18.0-20.0 Cr, 8.0-10.0 Ni, 2.00 Mn, 1.0 Si, 0.08 C, 0.08 S, 0.045 P) used in BWRs can be mitigated by reducing the ECP of the stainless steel to values below −0.230 V(SHE). An effective method of achieving this objective is to use HWC. However, high hydrogen additions, e.g., of about 100 ppb or greater, that may be required to reduce the ECP below the critical potential, can result in a higher radiation level in the steam-driven turbine section from incorporation of the short-lived N-16 species in the steam. For most BWRs, the amount of hydrogen addition required to provide mitigation of IGSCC of pressure vessel internal components results in an increase in the main steam line radiation monitor by a factor of five from its background level. This increase in main steam line radiation can cause high, even unacceptable, environmental dose rates that can require expensive investments in shielding and radiation exposure control. Thus, recent investigations have focused on using minimum levels of hydrogen to achieve the benefits of HWC with minimum increase in the main steam radiation dose rates.

An effective approach to achieve this goal is to either coat or alloy the stainless steel surface with palladium or any other platinum group metal. The presence of palladium on the stainless steel surface reduces the hydrogen demand to reach the required IGSCC critical potential of −0.230 V(SHE). The techniques used to date for palladium coating include electroplating, electroless plating, plasma deposition and related high-vacuum techniques. Palladium alloying has been carried out using standard alloy preparation techniques. Both of these approaches are ex situ techniques in that they cannot be practiced while the reactor is in operation.

U.S. Pat. No. 5,135,709 to Andresen et al. discloses a method for lowering the ECP on components formed from carbon steel, alloy steel, stainless steel, nickel-based alloys or cobalt-based alloys which are exposed to high-temperature water by forming the component to have a catalytic layer of a platinum group metal. As used herein, the term “high temperature water” means water having a temperature of about 150° C. or greater, steam or the condensate thereof. As used therein, the term “catalytic layer” means a coating on a substrate, or a solute in an alloy formed into the substrate, the coating or solute being sufficient to catalyze the recombination of oxidizing and reducing species at the surface of the substrate. As used herein, the term “platinum group metal” means metals from the group consisting of platinum, palladium, osmium, ruthenium, iridium, rhodium, and mixtures thereof.

In nuclear reactors, ECP is increased by higher levels of oxidizing species, e.g., up to 200 ppb or greater of oxygen in the water measured in the recirculation piping, from the radiolytic decomposition of water in the core of the nuclear reactor. The method disclosed in U.S. Pat. No. 5,135,709 further comprises providing a reducing species in the high-temperature water that can combine with the oxidizing species. In accordance with this known method, high concentrations of hydrogen, i.e., about 100 ppb or more, must be added to the water to provide adequate mitigation to materials outside the reactor core region, and still higher concentrations are needed to afford mitigation to materials in the reactor core.

The formation of a catalytic layer of a platinum group metal on an alloy from the aforementioned group catalyzes the recombination of reducing species, such as hydrogen, with oxidizing species, such as oxygen or hydrogen peroxide, that are present in the water of a BWR. Such catalytic action at the surface of the alloy can lower the ECP of the alloy below the critical potential where IGSCC is minimized. As a result, the efficacy of hydrogen additions to high-temperature water in lowering the ECP of components made from the alloy and exposed to the injected water is increased many-fold. Furthermore, it is possible to provide catalytic activity at metal alloy surfaces if the metal substrate of such surfaces contains a catalytic layer of a platinum group metal. Relatively small amounts of the platinum group metal are sufficient to provide the catalytic layer and catalytic activity at the surface of the metal substrate. For example, U.S. Pat. No. 5,135,709 teaches that a solute in an alloy of at least about 0.01 wt. %, preferably at least 0.1 wt. %, provides a catalytic layer sufficient to lower the ECP of the alloy below the critical potential. The solute of a platinum group metal can be present up to an amount that does not substantially impair the metallurgical properties, including strength, ductility, and toughness of the alloy. The solute can be provided by methods known in the art, for example by addition to a melt of the alloy or by surface alloying. In addition, a coating of the platinum group metal, or a coating of an alloy comprised of a solute of the platinum group metal as described above, provides a catalytic layer and catalytic activity at the surface of the metal. Suitable coatings can be deposited by methods well known in the art for depositing substantially continuous coatings on metal substrates, such as plasma spraying, flame spraying, chemical vapor deposition, physical vapor deposition processes such as sputtering, welding such as metal inert gas welding, electroless plating, and electrolytic plating.

Thus, lower amounts of reducing species such as hydrogen are effective in reducing the ECP of the metal components below the critical potential, because the efficiency of recombination of oxidizing and reducing species is increased many-fold by the catalytic layer. Reducing species that can combine with the oxidizing species in the high-temperature water are provided by conventional means known in the art. In particular, reducing species such as hydrogen, ammonia, or hydrazine are injected into the feedwater of the nuclear reactor.

A need exists to provide for improved control over the deposition of metals on the surface of components to protect them from corrosion and intergranular stress corrosion cracking. The present invention seeks to satisfy that need.

### SUMMARY OF THE INVENTION

In the majority of instances of BWR operation, zinc is added in the form of zinc ions to control shut-down dose rates arising as a result of accumulation of cobalt-60 (⁶⁰Co) in the recirculation piping associated with the reactor. It has been discovered by the present inventors that the presence of zinc ions in the water has a negative influence on the active noble metal species available for the noble metal incorporation process. The presence of zinc ions results in the formation of a zinc-containing spinel-type oxide film on reactor internal surfaces and associated components where the zinc atoms occupy sites that would otherwise have been occupied by the undesirable ⁶⁰Co isotope. Because of the higher solubility of zinc in water in the temperature range used for noble metal chemical addition, i.e., about 120°-610° F. or higher, release of zinc from reactor internal surfaces can occur during the noble metal incorporation process. The released zinc ions may then react with the noble metal species present in anionic form to cause the formation of a precipitate containing the noble metal species, thereby lowering the concentration of the noble metal species available for incorporation.

It has been discovered, according to the present invention, that it is possible to achieve improved noble metal loading on reactor metal surfaces disposed in high temperature water containing zinc by introducing the noble metal species into the high temperature water in positively chewed cationic form. In this way, precipitate formation with zinc cations is essentially eliminated, thereby minimizing the negative effect the presence of zinc may have on incorporation of noble metals species on the reactor surfaces.

In one aspect, the invention provides a method for reducing corrosion of alloy components in a water cooled nuclear reactor or associated components in which the water of the reactor contains zinc cations, comprising the step of injecting into the water of the reactor a noble metal cation releasing compound which releases noble metal cations into the water under operating reactor thermal conditions with essentially no precipitate formation between the zinc and the released noble metal.

In another aspect, there is provided a method for reducing corrosion of alloy components such as stainless steel components, in a water-cooled nuclear reactor or associated components, wherein a solution of a noble metal cation releasing compound containing a noble metal is injected into the reactor water containing zinc ions at a temperature of about to 120° to 610° F., for example about 300° to 450° F., in an amount such that, upon decomposition of the noble metal compound under the operating reactor thermal conditions, cations of the noble metal are released at a rate such that the concentration of the noble metal in the water is sufficient, once incorporated on the alloy component's surface, to reduce the electrochemical corrosion potential of the alloy components to a level below the critical potential, with essentially no precipitate formation between the zinc and the noble metal.

In a further aspect, the invention provides a method for reducing corrosion of alloy components in a water cooled nuclear reactor or associated components, wherein zinc and a noble metal cation releasing compound are added to the water of the rector such that the noble metal cation releasing compound releases noble metal cations into the water under operating reactor thermal conditions. The zinc may be added prior to or subsequent to the noble metal cation releasing compound.

As a result of the invention, it is possible to achieve good corrosion resistance of metal surfaces disposed in high temperature water in the presence of zinc as a result of minimal precipitate formation between the noble metal and the zinc.

### BRIEF DESCRIPTION OF THE DRAWINGS

FIG. 1 is a schematic showing a partially cutaway perspective view of a conventional BWR; and

FIG. 2 shows the effect of zinc in sodium hexahydroxy platinate (NaPt(OH)₆) solutions on platinum concentrations.

### DETAILED DESCRIPTION OF PREFERRED EMBODIMENTS

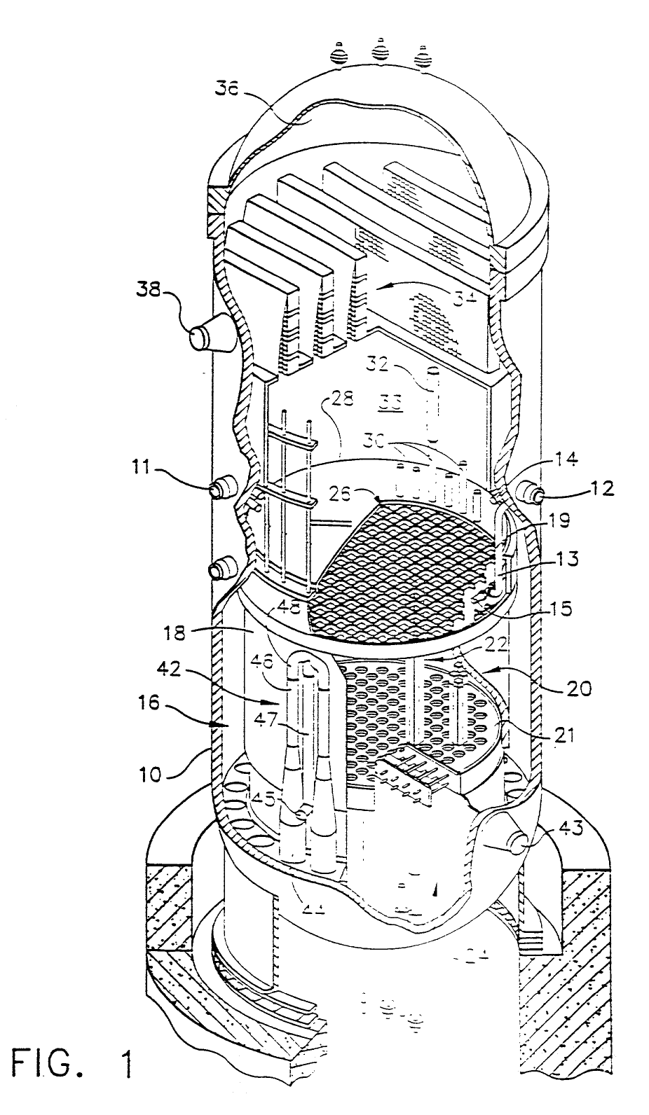

The fluid flow in a boiling water reactor will be generally described with reference to FIG. 1. Feedwater is admitted into a reactor pressure vessel (RPV) 10 via a feedwater inlet 12 and a feedwater sparger 14, which is a ring-shaped pipe having suitable apertures for circumferentially distributing the feedwater inside the RPV. A core spray inlet 11 supplies water to a core spray sparger 15 via core spray line 13. The feedwater from feedwater sparger 14 flows downwardly through the downcomer annulus 16, which is an annular region between RPV 10 and core shroud 18. Core shroud 18 is a stainless steel cylinder which surrounds the core 20 comprising numerous fuel assemblies 22 (only two 2×2 arrays of which are depicted in FIG. 1). Each fuel assembly is supported at the top by top guide 19 and at the bottom by core plate 21. Water flowing through downcomer annulus 16 then flows to the core lower plenum 24.

The water subsequently enters the fuel assemblies 22 disposed within core 20, wherein a boiling boundary layer (not shown) is established. A mixture of water and steam enters core upper plenum 26 under shroud head 28. Core upper plenum 26 provides standoff between the steam-water mixture exiting core 20 and entering vertical standpipes 30, which are disposed atop shroud head 28 and in fluid communication with core upper plenum 26.

The steam-water mixture flows through standpipes 30 and enters steam separators 32, which are of the axial-flow centrifugal type. The separated liquid water then mixes with feedwater in the mixing plenum 33, which mixture then returns to the core via the downcomer annulus. The steam passes through steam dryers 34 and enters steam dome 36. The steam is withdrawn from the RPV via steam outlet 38.

The BWR also includes a coolant recirculation system which provides the forced convection flow through the core necessary to attain the required power density. A portion of the water is sucked from the lower end of the downcomer annulus 16 via recirculation water outlet 43 and forced by a centrifugal recirculation pump (not shown) into jet pump assemblies 42 (only one of which is shown) via recirculation water inlets 45. The BWR has two recirculation pumps, each of which provides the driving flow for a plurality of jet pump assemblies. The pressurized driving water is supplied to each jet pump nozzle 44 via an inlet riser 47, an elbow 48 and an inlet mixer 46 in flow sequence. A typical BWR has 16 to 24 inlet mixers.

In the following discussion, for convenience of description, reference will be made to the use of platinum or mixtures of platinum and rhodium as typical noble metals. It is understood, however, that the invention is not limited to the use of platinum and rhodium, and other platinum group metals may be used.

The term “platinum Croup metal”, as used herein, means platinum, palladium, osmium, ruthenium, iridium, rhodium and mixtures thereof. Mixtures of platinum group compounds may also be used. Examples of mixtures of the compounds which may be used are mixtures containing platinum and iridium, and platinum and rhodium.

The presence of iridium or rhodium with the platinum gives good long-term durability. It has been found that a combination of about 40-80 ppb Pt and 10-35 ppb Rh, for example concentrations of about 60 ppb Pt and about 20 ppb Rh in ionic form in water, provides good adherent properties of noble metal over extended periods of time. However, 1:1 ratios of Pt:Rh have also been used with success.

The term “cation-releasing noble metal compound”, as used herein, means a noble metal-containing compound which releases noble metal as cations (e.g. Pt²⁺) or as cationic species containing noble metal species with attached ligands, such as for example Pt(OH)⁺, Pt(NH₃)₄²⁺ into the reactor water under operating reactor thermal conditions. Such compounds may be organometallic, organic or inorganic, and may be soluble or insoluble in water (i.e. may form solutions or suspensions in water and/or other media such alcohols and/or acids). Examples of such compounds are platinum chloride, palladium chloride, palladium acetyl acetonate, platinum acetyl acetonate. palladium nitrate, platinum nitrate, palladium acetate, platinum acetate, Pt(NH₃)₄(NO₃)₂ and Pt(NH₃)₂(NO₂)₂. Other examples are platinum(IV) oxide (Pt(IV)O₂), platinum(IV) oxide-hydrate (Pt(IV)O₂.xH₂O, where x is 1-10), rhodium(II) acetate (Rh(II)ac₂). Rh(III) nitrate (Rh(III)(NO₃)₃), rhodium(III) oxide (Rh(III)₂O₃), rhodium(III) oxide-hydrate (Rh(III)₂O₃.xH₂O, where x is 1-10), rhodium(II) phosphate (Rh(III)PO₄) and rhodium(III) sulphate (Rh(III)₂(SO₄)₃). In general, any species of the form Pt(X)²⁺, Pt(X)⁴⁺, Pd(X)²⁻, Rh(X)³⁺ where X is an organic or inorganic ligand may be used, but not limited to Pt, Pd or Rh.

The metal compound may be injected in situ into the reactor in the form of an aqueous solution or suspension. As used in the claims hereafter, the term “solution” means solution or suspension. Solutions and suspensions may be formed using media well known to those skilled in the art. Examples of suitable media in which solutions and/or suspensions are formed, are water, alkanols such as ethanol, propanol, n-butanol, and acids such as lower carboxylic acids, e.g. acetic acid, propionic acid and butyric acid, or ketones such as acetone and acetylacetone.

When the noble metal cation-releasing compound solution or suspension enters the high-temperature water, the compound decomposes very rapidly to release the cationic species (e.g. Pt²⁺) into the reactor water with or without the ligand. These species are then incorporated in the reactor surface, usually by incorporation into the metal (typically stainless steel) oxide film. Use of mixtures of noble metal cation-releasing compounds results in release and deposition of both noble metals, usually by way of incorporation of the noble metals on the oxided stainless steel surfaces. While not being bound to any theory, it is believed that they undergo conversion to metal during the incorporation process.

Reaction of the noble metal with cationic zinc ions (Zn²⁺) present in the water is minimized due to the noble metal being in cationic form. Typically, zinc is present in the reactor water in an amount of about 10 to 500 ppb, but this amount may be more or less, depending on the conditions present in the reactor. The inventors have found that no precipitate is observed with solutions of 500 ppb zinc nitrate when platinum is added, for example as platinum chloride or tetrammineplatinum nitrate. Improved noble metal loading is accordingly obtained over that where the noble metal is in a form (e.g., anion) which reacts with zinc ions to form a precipitate.

The solution or suspension of the noble metal compound is typically introduced into the high-temperature water initially. No further agents, such as hydrogen or other reducing agents, needed to be introduced into the high-temperature water when the noble metal cation-releasing compound solution or suspension is injected into and decomposes in the high-temperature reactor water.

The process of the present invention is distinguished from the processes of U.S. Pat. Nos. 5,130,080 and 5,130,181 to Niedrach. The Niedrach patents teach that it is possible to electrolessly plate oxide films using conventional electroless plating techniques. Conventional electroless plating is carried out at relatively low temperatures, typically in the region of 50° to 80° C., possibly lower, and requires the presence of an added reducing agent, typically sodium hypophosphite, to supply electrons for reduction of the noble metal ions to the metal. The reaction takes place only on a catalytic surface which has been sensitized/activated beforehand, for example with stannous chloride, and the process results in a build-up of metal coating on the surface which eventually coats the entire surface with deposited metal. The electroless plating bath typically contains high ionic concentrations, of the order of thousands of ppm, of chemicals, including, for example, palladium (II) chloride, ammonium hydroxide, ammonium chloride, disodium EDTA and hydrazine, as well as a reducing agent (e.g. sodium hypophosphite). The pH of the electroless bath is usually in the region of 9.0 to 10.5 in view of the presence of base (ammonium hydroxide and ammonium chloride).

The process of the present invention does not rely on the use of electroless plating techniques or other techniques which result in the metal being plated on the oxide surface. In the present process, the metal compound or mixture of metal compounds is introduced into the high-temperature water containing zinc in an amount such that the concentration of the metal(s) in the water is very low, i.e. in the ppb range, but is sufficient such that when present on the metal component after incorporation, the ECP is lowered below the critical potential required for mitigation from stress corrosion cracking with very low levels of hydrogen.

The compound solution or suspension may be injected into the high-temperature water while the reactor is operating and generating nuclear heat (full power operation), or during cool down, during outage, during heat-up, during hot standby, or during low power operation. The noble metal may be introduced into residual heat removal (RHR) piping, recirculation piping, feedwater line, core delta P line, jet pump instrumentation line, control rod drive cooling water lines, water level control points, reactor water clean-up (RWCU) system (discussed in more detail below) which may or may not be in operation during the application period, or any other location which provides introduction of the noble metal into the reactor water and good mincing with the water. High temperature water can be found in a variety of known apparatus, such as water deaerators, nuclear reactors (BWR's and PWR's), and steam-driven power plants.

Typically, the metal compound is added in such an amount to produce a metal concentration in the reactor water of no higher than 2000 ppb, for example 0.1 to 1000 ppb. More typically, the concentration in the water is 0.1 to 1 ppm, for example 1 to 500 ppb, more usually 5 to 100 ppb.

The temperature of the water when noble metal is added to the reactor water is typically in the range of 120°-550° F. (BWR), 120°-610° F. (PWR). The temperature is generally in the range of 212°-350° F., more usually about 340°-360° F. If noble metal addition is performed at full power operation, the temperature will be about 550° F.

At the very low levels of metal(s) introduced into the reactor, the stainless steel oxide surface is not covered completely with metal. Typically, the oxide surface has metal present in an amount of about 0.1-15 atomic %, for example 0.5-10 atomic %, more usually 2-5 atomic %.

It is important to monitor the noble metal concentration during the application process so that the desired concentration can be maintained within the reactor water. The concentration is desirably continuously monitored, typically by taking samples from any sampling location and analyzing for the noble metal concentration.

The depth of metal in the oxide surface is generally in the range of 100 to 1000 Angstroms, more usually 200 to 500 Angstroms. The external appearance of the oxided alloy treated according to the present process does not differ from the appearance of untreated stainless steel oxide. The noble metal containing surface does not have a bright metallic luster as is generally obtained with electroplating or electroless coating processes, nor is the surface 100% covered with noble metal.

In the present process, only very dilute compound solution or suspension is injected into the high-temperature water. No reducing agents (including hydrogen), acids and bases, are added. As a result, the typical pH of the water at ambient temperature is in the region of 6.5 to 7.5, and at higher operating temperatures is lower, Generally in the region of about 5.5-5.8, for example 5.65. This is due to increased dissociation of the water at the higher temperatures. During noble metal application, the pH may be 4.5 to 9.5, depending on other ionic species in the water.

An operating BWR has very stringent coolant water conductivity levels which must be observed. Typically, the conductivity of the coolant water must not exceed 0.3 μS/cm, and more usually must be less than 0.1 μS/cm. Such conductivity levels are adversely impacted by high concentrations of ionic species, and every effort is made in the present process to ensure that reactor ionic concentrations are maintained as low as possible after clean-up, preferably less than 5 ppb. The process in particular maintains chloride ion at a very low level in view of its corrosive nature.

The time period over which the process of noble metal application is conducted will depend on the concentration and temperature conditions. Usually, the noble application is carried out over a period ranging from 4 hours to one week, more typically 4 to 48 hours, provided that any limits set on pH and conductivity are maintained.

A typical plant application process may be performed at a temperature of 280±20° F. over a period of about 24 to 48 hours. The noble metal concentration during the application process should be maintained at a level of about 40 to 1000 ppb while not allowing the conductivity of the reactor to exceed undesirable levels, typically not to exceed 30 μS/cm, over this limited period of time.

The present process does not involve any catalytic activation/sensitization of the stainless steel oxide surface. The use of stannous chloride to achieve such activation would be incompatible with operation of the BWR and the stringent conductivity limits on the coolant water referred to above.

After completion of the application process, the plant will proceed to its normal outage related activities, while the RWCU system is still in operation in order to clean up residual noble metal before plant start-up. Confirmation of deposition of noble metal on the internal surface of the reactor and components thereof is accomplished by (a) mass balance calculations during application, (b) surface analysis of accessible regions and analyzing for noble metal content during subsequent outages and (c) by hydrogen benchmark (ramping) after plant start-up.

While not being bound by theory, it is understood that the metal in ionic form, for example platinum and/or rhodium, is deposited on the reactor surface, typically by way of incorporation into the stainless steel oxide film. Thermal decomposition of the compound forms metal ions which apparently replace iron, nickel and/or chromium atoms in reactor/component surface. It is believed that the metal ions are incorporated into the oxide film, resulting in a metal-doped oxide film. The metal, such as platinum either alone or with rhodium, may for example be incorporated within or on the surface of the oxide film. The oxide film is believed to include mixed nickel, iron and chromium oxides containing zinc, if the plant has operated with natural or added zinc for some time.

The ECPs of the stainless steel components all drop by approximately 0.5 to 0.6 V after injection of the noble metal and subsequent addition of low levels of hydrogen. It is possible to reduce the ECP of Type 304 stainless steel to IGSCC mitigation values without injecting hydrogen when an organic or an organometallic compound has been injected into the water. The catalytic oxidation of organics on noble metal-doped surfaces consumes oxygen, thereby lowering the dissolved oxygen content in the high temperature water. Good results are also obtained when an inorganic metal compound(s) is used. Moreover, cleanup of the water is easier when inorganic(s) such as nitrates are used as compared to organics such as formates and acetates. For this reason, inorganic compounds, particularly inorganic platinum group metal compounds (e.g. noble metal nitrates and nitrites), are typically used.

Following injection and incorporation of the metal(s) in the oxided stainless steel surfaces, the water is subjected to a conventional clean-up process to remove ionic materials such as nitrate ions present in the water. This clean-up process is usually carried out by passing a fraction of the water removed from the bottom head of the reactor and recirculation piping through an ion exchange resin bed, and the treated water is then returned to the reactor via the feedwater system. Hydrogen may subsequently be introduced into the water some time after the doping reaction, for example 1 to 72 hours after injection and incorporation of the metal atoms in the oxided surface, to catalyze recombination of hydrogen and oxygen on the metal doped surfaces. As hydrogen is added, the electrochemical corrosion potential of the metal-doped oxide film on the stainless steel components is reduced to values which are much more negative than when low levels of hydrogen are injected into a BWR having stainless steel components which are not doped with the noble metal.

The noble metal compound is usually injected at a point downstream of the recirculation water outlet 43 (see FIG. 1). The high temperatures as well as the gamma and neutron radiation in the reactor core act to decompose the compound, thereby releasing noble metal cations or species for incorporation in the oxide film of the reactor surfaces.

The noble metal injection solution may be prepared for example by dissolving the noble metal compound in ethanol. The ethanol solution is then diluted with water. Alternatively, a water-based suspension can be formed, without using ethanol, by mixing the noble metal compound in water. The widely used approach is to use a solution of noble metal compound in water.

The method of the invention may also be carried out by adding zinc and a noble metal cation releasing compound to the water of the rector such that the noble metal cation releasing compound releases noble metal cations into the water under operating reactor thermal conditions. The order of addition is not critical, The zinc may be added prior to or subsequent to the noble metal cation releasing compound.

The noble metal either deposits or is incorporated onto the reactor surface, typically into the (stainless steel) oxide film via a thermal decomposition process of the noble metal compound. As a result of that decomposition, noble metal cations (species) become available to replace atoms, e.g., iron atoms, in the oxide film, thereby producing a noble metal-doped oxide film on stainless steel. As used herein, the term “atoms” means atoms, ions or uncharged species.

The present invention offers the advantage that steel surfaces can be doped with noble metal to good loading levels while zinc is present in the reactor water using an in situ technique (while the reactor is operating) which is simple in application and also relatively inexpensive. The technique can be applied to operating BWRs and PWRs and their associated components, such as steam generators.

The invention will now be further illustrated with reference to the following working example.

### EXAMPLE

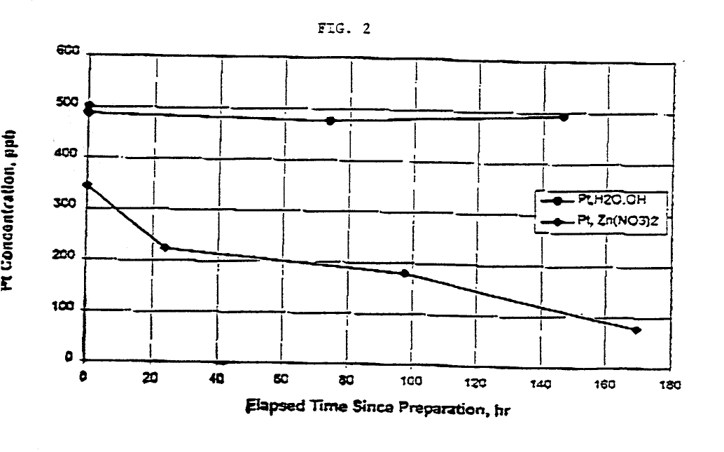

FIG. 2 shows the effect of zinc in sodium hexahydroxy platinate (NaPt(OH)₆) solutions on platinum concentrations. Sodium hexahydroxy platinate (>50 ppm Pt) was mixed with zinc nitrate (500 ppm) to yield a visible precipitate. While no precipitate was visible with Pt concentrations of 100-500 ppb, a decrease in the Pt concentration was observed over time when sodium hexahydroxy platinate was mixed with zinc nitrate (see FIG. 2).

The overall effect of this zinc interference is the reduction of noble metal loading on reactor internal surfaces. This results either in poor ECP response in the presence of H2 and/or poor durability of the catalytic surfaces. The present invention minimizes zinc interference by reducing precipitate formation between zinc and noble metal, thereby improving noble metal loading.

The foregoing method has been disclosed for the purpose of illustration. Variations and modifications of the disclosed method will be readily apparent to practitioners skilled in the art of hydrogen water chemistry. For example, metals other than platinum/rhodium can be applied using this technique, e.g., other platinum group metals. A platinum group metal can be injected in the form of an organic, organometallic or inorganic compound which produces noble metal cations or species in the high temperature reactor water, to reduce the electrochemical corrosion potential of stainless steel reactor components even in the absence of hydrogen injection. It may also be possible to incorporate non-platinum group metals in oxide films on stainless steel components, e.g., zirconium and titanium, using the technique of the invention. All such variations and modifications are intended to be encompassed by the claims set forth hereinafter.

1. A method for reducing corrosion of alloy components in a water cooled nuclear reactor or associated components in which the water of the reactor contains zinc, comprising the step of injecting into the water of the reactor a noble metal cation releasing compound which releases noble metal cations into the water under operating reactor thermal conditions.

2. The method as defined in claim 1, wherein said noble metal cation-releasing compound is added to said rector water in an amount effective to produce a noble metal concentration of 0.1 to 1000 ppb.

3. The method as defined in claim 1, wherein said components have an oxide film on a surface thereof and said noble metal is incorporated in said oxide film.

4. The method as defined in claim 1, wherein said noble metal is present in an amount of about 0.01 μg/cm² to about 100 μg/cm².

5. The method as defined in claim 1, wherein the reactor water is at a temperature within the range of about 120° to 610° F.

6. The method as defined in claim 1, wherein said noble metal is a platinum group metal.

7. The method as defined in claim 1, wherein said noble metal cation releasing compound is a formula Pt(X)²⁺, Pt(X)⁴⁺, Pd(X)²⁺, Rh(X)³⁺ where X is an organic or inorganic ligand.

8. The method as defined in claim 6, wherein said platinum group metal is platinum.

9. The method as defined in claim 1, wherein the noble metal cation-releasing compound is selected from the group consisting of platinum chloride, palladium chloride, palladium acetyl acetonate, platinum acetyl acetonate, palladium nitrate, platinum nitrate, palladium acetate, platinum acetate, Pt(NH₃)₄(NO₃)₂, Pt(NH₃)₂(NO₂)₂, platinum(IV) oxide (Pt(IV)O₂), platinum(IV) oxide-hydrate (Pt(IV)O₂.xH₂O, where x is 1-10), rhodium(II) acetate (Rh(II)ac₂), Rh(III) nitrate (Rh(III)(NO₃)₃), rhodium(III) oxide (Rh(III)₂O₃), rhodium(III) oxide-hydrate (Rh(III)₂O₃.xH₂O, where x is 1-10), rhodium(II) phosphate (Rh(III)PO₄) and rhodium(III) sulphate (Rh(III)₂(SO₄)₃), and mixtures thereof.

10. The method as defined in claim 6, wherein a mixture of Pt(NH₃)₄(NO₃)₂ and Na₃Rh(NO₂)₆ is used.

11. The method as defined in claim 6, wherein a mixture of Pt(NH₃)₂(NO₂)₂ and Na₃Rh(NO₂)₆ is used

12. The method as defined in claim 1, wherein said zinc in present in an amount of 1 to 500 ppb.

13. A method for reducing corrosion of alloy components in a water-cooled nuclear reactor or associated components, comprising the step of injecting a solution of a noble metal cation-releasing compound into the water of said reactor containing zinc, said water being at a temperature within the range of 120°-610° F., said compound undergoing decomposition at said selected temperature to release cations of said noble metal at a rate such that the concentration of said noble metal in the water of said reactor is sufficient, once doped on said alloy components, to reduce the electrochemical corrosion potential of said alloy components to a level below the critical potential to mitigate against intergranular stress corrosion cracking.

14. The method as defined in claim 13, wherein said critical potential is −230 mV (SHE).

15. The method as defined in claim 1, further comprising the step of injecting hydrogen into the water of said reactor.

16. The method as defined in claim 15, wherein said noble metal cation-releasing compound is injected at a rate such that the concentration of said noble metal in the water is sufficient, once doped on said alloy components, to reduce the electrochemical corrosion potential of said alloy components in the presence of low levels of hydrogen to a level below the critical potential to mitigate against intergranular stress corrosion cracking.

17. The method as defined in claim 16, wherein said critical potential is −230 mV (SHE).

18. A method for reducing corrosion of alloy components in a water cooled nuclear reactor or associated components, comprising adding to the water of the rector zinc and a noble metal cation releasing compound which releases noble metal cations into the water under operating reactor thermal conditions.

19. The method according to claim 18, wherein said zinc is added prior to said noble metal cation releasing compound.

20. The method according to claim 18, wherein said zinc is added subsequent to said noble metal cation releasing compound.
